(19) United States
(12) Patent Application Publication
(10) Pub. No.: US 2007/0035489 A1
(43) Pub. Date: Feb. 15, 2007

(54) Flat panel display device and control method of the same

(75) Inventor: Jae Sung Lee, Seoul (KR)

Correspondence Address: LEE & MORSE, P.C., 3141 FAIRVIEW PARK DRIVE, SUITE 500, FALLS CHURCH, VA, 22042, US

(73) Assignee: Samsung SDI Co., Ltd.

(21) Appl. No.: 11/500,499

(22) Filed: Aug. 8, 2006

(30) Foreign Application Priority Data
Aug. 8, 2005 (KR) 10-2005-0072507

(51) Int. Cl. G09G 3/30

(52) U.S. Cl. 345/77

(57) ABSTRACT

A control method of a flat panel display device includes the steps of: receiving external power supply signals and initial signals and supplying driving power supply to each component including a scan driver and a data driver; storing a plurality of register set values for controlling a level of brightness of an initial screen of the pixel unit; outputting sense signals corresponding thereto by sensing the level of brightness of peripheral light and selecting register values corresponding to predetermined sense signals corresponding to the level of brightness of the peripheral light among the plurality of register set values; and displaying the initial screen on the pixel unit by applying the level of brightness controlled by the register values.

### BACKGROUND OF THE INVENTION

1. Field of the Invention

The present invention relates to a flat panel display device and a control method of the same. More particularly, the present invention is directed to a flat panel display device and a control method of the same which receives power supply signals from an external source and then senses a brightness level of peripheral light before an initial screen is displayed so that the initial screen of a pixel unit can be displayed at a brightness level corresponding to the brightness level of the peripheral light.

2. Description of the Related Art

Recently, various flat panel display (FPD) devices capable of reducing weight and volume, which are disadvantages of a cathode ray tube (CRT), have been developed. As the flat panel display device, there are a liquid crystal display, a field emission display, a plasma display panel and a light emitting display, etc.

However, since conventional flat panel display devices emit light at a constant brightness independent of a brightness of peripheral light or, i.e., ambient or environment light, when displaying an image corresponding to a predetermined gray scale, conventional flat panel display devices exhibit a drawback or disadvantage in that sharpness of the image to be displayed is deteriorated when brightness of the circumstance (i.e., ambient or environment light) is brighter than the image displayed or when brightness of the circumstance is dark.

In particular, since an initial screen of the pixel of the flat panel display device is displayed at a constant brightness regardless of the level of brightness of the circumstance, there are disadvantages in that when ambient or environment light is bright, the initial screen may not be easily viewable, and when ambient or environmental light is dark, the initial screen may be too bright and cause the eyes of the viewer to be dazzled or temporarily blinded.

### SUMMARY OF THE INVENTION

The present invention is therefore directed to a flat panel display device and a control method of the same, which receives power supply and then senses peripheral light of the external of the pixel unit before an initial screen is displayed on the pixel unit so that the initial screen of the pixel unit can be displayed at a level of brightness corresponding to a level of brightness of the peripheral or ambient light.

It is therefore a feature of an embodiment of the invention to provide a flat panel display device comprising: a pixel unit comprising a plurality of scan lines, a plurality of emission control lines and a plurality of data lines, and displaying an image corresponding to data signals transmitted to the plurality of data lines; a scan driver transmitting scan signals to the scan lines and transmitting emission control signals to the emission control lines; a data driver transmitting the data signals to the data lines; a timing controller providing control signals and/or data to the scan driver and the data driver; and a brightness control unit generating sense signals corresponding to a level of brightness of peripheral light and controlling a level of brightness of the pixel unit depending on the sense signals, wherein the brightness control unit senses peripheral light of the pixel unit before an initial screen is displayed on the pixel unit and then, controls the initial screen originally displayed on the pixel unit at a level of brightness corresponding to a level of brightness of the peripheral light.

Also, according to an embodiment of the present invention, there is provided a control method of a flat panel display device comprising the steps of: receiving external power supply signals and initial signals and supplying driving power supply to each component including a scan driver and a data driver; storing a plurality of register set values for controlling the level of brightness of an initial screen of the pixel unit; outputting sense signals corresponding thereto by sensing peripheral light and selecting register values corresponding to predetermined sense signals corresponding to the level of brightness of the peripheral light among the plurality of register set values; and displaying the initial screen on the pixel unit by applying the level of brightness controlled by the register values.

Also, according to another embodiment of the present invention, there is provided a control method of a flat panel display device, wherein a control method of a flat panel display device displays an image by receiving emission control signals and data signals, comprising the steps of: (a) receiving external power supply signals and initialization signals and supplying driving power supply to each component including a scan driver and a data driver; (b) controlling emission control signals or data signals corresponding to the level of brightness of peripheral light; and (c) allowing the pixel unit to display an initial screen having a level of brightness controlled through step (b) by supplying the driving power supply to the pixel unit.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 is a schematic diagram illustrating a structure of a flat panel display device according to an embodiment of the present invention;

FIG. 2 is a schematic diagram illustrating an example of a brightness control unit for the flat panel display device as illustrated in FIG. 1;

FIG. 3 is a schematic diagram illustrating an example of a gamma correcting circuit provided in the brightness control unit illustrated in FIG. 2;

FIG. 4 is a circuit diagram illustrating an example of a pixel adopted into a flat panel display device according to the present invention; and

FIG. 5 is a flow chart illustrating a driving method for a flat panel display device according to an embodiment of the present invention.

### DETAILED DESCRIPTION OF THE INVENTION

Korean Patent Application No. 10-2005-0072507, filed on Aug. 8, 2005, in the Korean Intellectual Property Office, and entitled: “Flat Panel Display Device and Control Method of the Same,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, it is to be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

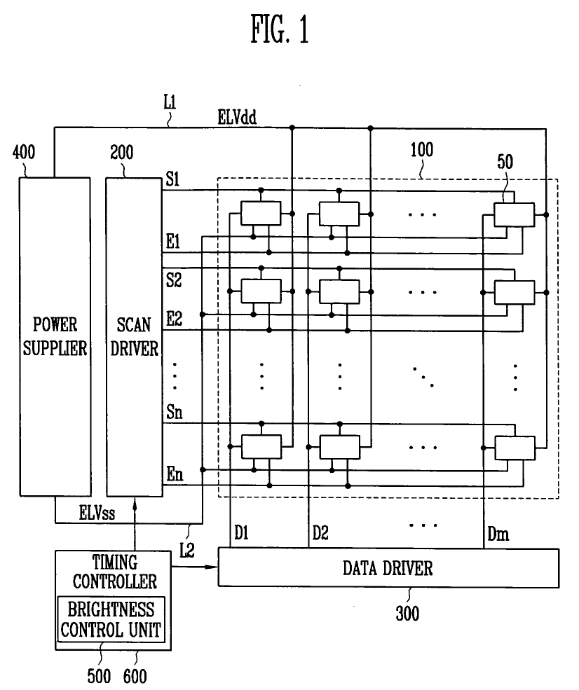

FIG. 1 is a schematic diagram illustrating a structure of a flat panel display device according to an embodiment of the present invention. Although FIG. 1 illustrates a structure of an organic light emitting display device of a flat panel display device, a flat panel display device of the present invention is not limited thereto. In other words, a flat panel display device of the present invention may be a liquid crystal display, a field emission display, a plasma display panel, an organic light emitting display device or any other type of flat panel display device.

Referring to FIG. 1, an organic light emitting display device of the present invention comprises a pixel unit 100, a scan driver 200, a data driver 300, a power supplier 400 and a timing controller 600.

The pixel unit 100 comprises a plurality of pixels 50 electrically connected to n scan lines S1, S2, . . . , and Sn arranged in a row direction and m light emission control lines E1, E2, . . . , and En arranged in a column direction; a first power line L1 supplying a first power ELVdd to the plurality of pixels 50; and a second power source line L2 supplying a second power ELVss to the plurality of pixels 50. At this time, the second power source L2 , which is equivalently expressed, is formed throughout all regions of the pixel unit 100 so that it may be electrically connected to each pixel 50.

The scan driver 200 applies scan signals to the plurality of scan lines S1, S2, . . . , and Sn, and applies emission control signals to the plurality of emission control lines E1, E2, . . . , and En, by sequentially transmitting these signals to the plurality of pixels 50.

The data driver 300 transmits data signals to the plurality of data lines D1, D2, . . . , and Dm so that the pixel unit 100 can display an image corresponding to the data signals.

The power supplier 400 supplies the first power source ELVdd to the first power source line L1 and supplies the second power source ELVss to the second power source line L2.

The timing controller 600 generates data driving control signals and scan driving control signals by corresponding to external synchronizing signals to supply these control signals to the data driver 300 and the scan driver 200, respectively. The timing controller 600 also supplies data relating to the level of brightness of the exterior, i.e., peripheral, ambient or environment, to the data driver 300.

According to an embodiment of the present invention, the timing controller 600 comprises a brightness control unit 500 controlling an initial screen originally displayed on the pixel unit 100 by sensing peripheral or ambient light of the environment so that the pixel unit may be displayed at a level of brightness corresponding to the peripheral light.

However, the feature that the brightness control unit 500 is provided in the controller 600 is no more than an embodiment of the present invention, and the same operation can be implemented even though the brightness control unit 500 is not always provided in the controller 600. In other words, the brightness control unit 500 controls brightness of an image displayed by the pixel unit 100 in accordance with peripheral or ambient light. Therefore, when peripheral or ambient light is dark, although the pixel unit displays an image at low brightness, the displayed image may be sharply and clearly recognized and viewed by controlling the brightness of the pixel unit 100 to be low by application of low voltage.

On the contrary, when peripheral or ambient light is bright, the pixel unit must display an image at high brightness by controlling the brightness of the pixel unit 100 to be high by applying high voltage so that the displayed image can be sharply and clearly recognized and viewed.

According to the present invention, the brightness control unit 500 controls the brightness of the pixel unit in accordance with the brightness of the peripheral or ambient light while an image is displayed through the pixel unit 100, and controls the brightness of the initial image to be displayed at a brightness level corresponding to the peripheral or ambient light when an initial screen is originally displayed on the pixel unit 100.

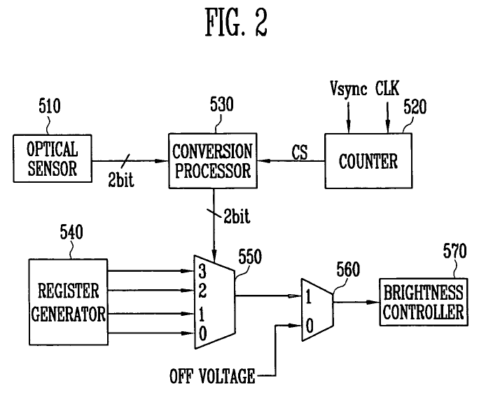

FIG. 2 is a schematic diagram illustrating an example of a brightness control unit for the flat panel display device as illustrated in FIG. 1.

Referring to FIG. 2, a brightness control unit comprises an optical sensor 510, a counter 520, a conversion processor 530, a register generator 540, a first selector 550, a second selector 560 and a brightness controller 570.

The optical sensor 510 senses the brightness of peripheral or ambient light by dividing it into a plurality of steps, and outputs sense signals corresponding to the brightness of the respective steps.

TABLE 1

Illumination of peripheral
light (LUX)

| | 50 | 100 | 150 | 200 |
|---|---|---|---|---|
| Sense signals | 00 | 01 | 10 | 11 |

Referring to Table 1, the brightness of peripheral light can be divided into a first state (50 lux), a second state (100 lux), a third state (150 lux) and a fourth state (200 lux).

At this time, assuming that the optical sensor 510 outputs a 2 bits digital signal as a sense signal corresponding to the brightness of the respective steps, it outputs a sense signal of ‘00’ in the first state and a sense signal of ‘01’ in the second state, respectively. Also, the optical sensor 510 outputs a sense signal of ‘10’ in the third state and a sense signal of ‘11’ in the fourth state, respectively.

Also, the optical sensor 510 senses peripheral or ambient light in a unit of a vertical synchronizing signal Vsync which is periodically input to the timing controller 600 from the external during the period before an initial screen is originally displayed on the pixel unit 100 since power has been supplied.

As mentioned before, this is for controlling the initial screen to be displayed at a brightness level corresponding to the level of brightness of the peripheral or ambient light, when the initial screen is originally displayed on the pixel unit 100.

The counter 520 counts predetermined numbers by means of the vertical synchronizing signal Vsync for a predetermined time to output counting signals Cs corresponding to the numbers. For example, in the case of the counter 520 that refers to the 2 digit value of 2 bit, the counter 520 is initialized to ‘00’ when the vertical synchronizing signal Vsync is input and counts numbers to ‘11’ while sequentially shifting a clock CLK signal.

Then, when the vertical synchronizing signal Vsync is input to the counter 520 again, the counter 520 is initialized again.

As described above, the counter 520 sequentially counts the numbers from ‘00’ to ‘11’ in one frame. The counter 520 then outputs the counting signals Cs corresponding to the counted numbers to the conversion processor 530.

The conversion processor 530 outputs control signals that select the set values of the respective registers using the counting signals Cs output from the counter 520 and the sense signals output from the optical sensor 510. That is, the conversion processor 530 outputs the control signals using sense signals corresponding to the light of the respective steps of peripheral light output from the optical sensor 510, and checks on which time point of one frame the sense signals are input through the counting signals.

Also, the conversion processor 530 can check which sense signals are input in a vertical synchronizing signal rather than in the counting signals even during the period before an initial screen is originally displayed on the pixel unit 100 since power has been supplied to the organic light emitting display device.

Also, the register generator 540 sets and stores a plurality of brightness control register values to control the brightness of the pixel unit. That is, the register generator 540 divides the register values into a plurality of steps to correspond to the brightness of peripheral or ambient light, and stores a plurality of register set values corresponding to the respective steps.

The first selector 550 selects predetermined register set values corresponding to the control signals output by the conversion processor 530 among the plurality of register set values stored in the register generator 540.

The second selector 560 receives set values of 1 bit for controlling on and off from the outside. When ‘1’ is selected, the brightness control unit 500 operates, and when ‘0’ is selected, the brightness control unit 500 does not operate. Accordingly, the second selector 560 can selectively control the level of brightness in accordance with the level of brightness of the peripheral or ambient light.

Also, the brightness controller 570 controls the brightness of the pixel unit 100 by corresponding to peripheral or ambient light in accordance with the operation as described above.

In particular, before the initial screen is displayed through the pixel unit, the level of brightness of peripheral or ambient light controls the level of brightness of the initial screen to correspond with the brightness of the peripheral or ambient light during the period that the vertical synchronizing signal is input, that is, when the initial screen is displayed through the pixel unit by being sensed in one frame unit.

In other words, the pixel unit preliminarily senses the brightness level of the peripheral or ambient light before it displays the initial screen to set the register values corresponding thereto, and then, when driving power is supplied to the pixel unit to display the initial screen, the pixel unit reflects the preset register values on the initial screen.

Meanwhile, the brightness controller 570 can control the brightness of the pixel unit corresponding to peripheral light by controlling width of emission control signals which are supplied to each pixel provided in the pixel unit 100 from the scan driver, i.e., ratio of emission intervals and non-emission intervals of the emission control signals.

According to an embodiment of the present invention, the brightness of the pixel unit may be controlled by controlling gamma values corresponding to each gray scale by performing a gamma correction corresponding to the peripheral or ambient light.

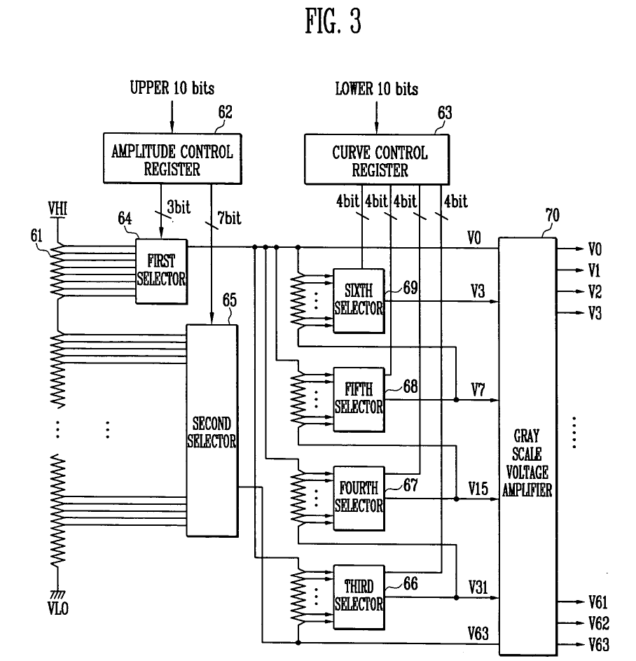

FIG. 3 is a schematic diagram illustrating an example of a gamma correcting circuit provided in the brightness control unit illustrated in FIG. 2.

Referring to FIG. 3, the gamma correcting circuit includes a ladder resistance 61, an amplitude control register 62, a curve control register 63, first to sixth selectors 64 to 69, and a gray scale voltage amplifier 70. The ladder resistance 61 determines the uppermost level voltage VHI supplied from the outside as a reference voltage, has a plurality of variable resistances included between the lowermost level voltage VLO and the reference voltage serially connected to each other, and generates a plurality of gray scale voltages through the ladder resistance 61.

Also, when the ladder resistance 61 value is small, an amplitude control range is reduced but the level of precision control improves.

Conversely, when the ladder resistance 61 value is large, the amplitude control range increases but the level of precision control is reduced.

The amplitude control register 62 outputs a register set value of 3 bits to the first selector 64 and outputs a resistor set value of 7 bit to the second selector 65. At this time, it is possible to increase the number of gray scales that can be selected by increasing the number of set bits and to differently select gray scale voltages by changing the register set values.

The curve control register 63 outputs register set values of 4 bits to the third to sixth selectors 66 to 69, respectively. At this time, the register set values can vary and can control the gray scale voltages that can be selected in accordance with the register set values. Among the register values generated by the register generator 540, the upper 10 bits are input to the amplitude control register 62 and the lower 16 bits are input to the curve control register 63, respectively, so that the upper 10 bits and the lower 16 bits are selected as the register set values.

The first selector 64 selects the gray scale voltage corresponding to the register set value of 3 bits set by the amplitude control register 62 among the plurality of gray scale voltages distributed through the ladder resistance 61 to output the gray scale voltage as the uppermost gray scale voltage. The second selector 65 selects the gray scale voltage corresponding to the register set value of 7 bits set by the amplitude control register 62 among the plurality of gray scale voltages distributed through the ladder resistance 61 to output the gray scale voltage as the lowermost gray scale voltage.

The third selector 66 distributes the voltages between the gray scale voltage output from the first selector 64 and the gray scale voltage output from the second selector 65 into the plurality of gray scale voltages through the resistance series and selects the gray scale voltage corresponding to the register set value of 4 bits to output the gray scale voltage.

The fourth selector 67 distributes the voltages between the gray scale voltage output from the first selector 64 and the gray scale voltage output from the third selector 66 into the plurality of gray scale voltages through the resistor series and selects the gray scale voltage corresponding to the register set value of 4 bits to output the gray scale voltage.

The fifth selector 68 selects the gray scale voltage corresponding to the register set value of 4 bits among the gray scale voltages between the first selector 64 an the fourth selector 67 to output the gray scale voltage.

The sixth selector 69 selects the gray scale voltage corresponding to the register set value of 4 bits among the plurality of gray scale voltages between the first selector 64 and the fifth selector 68 to output the gray scale voltage.

As described above, the curves of intermediate level gray scales are controlled in accordance with the register set values of the curve control register 63 so that gamma characteristics are easily controlled in accordance with the characteristics of the respective EL devices.

Also, the values of the respective ladder resistance 61 are set so that a difference in potential between gray scales is set to be larger as smaller gray scales are displayed when the gamma curve characteristic is to be concave, and the difference in potential between gray scales is set to be smaller as smaller gray scales are displayed when the gamma curve characteristic is to be convex.

The gray scale voltage amplifier 70 outputs a plurality of gray scale voltages corresponding to the plurality of gray scales to be displayed on the pixel unit 100. Referring to FIG. 4, the output of gray scale voltages corresponding to 64 gray scales is described.

As described above, the gamma correcting circuit is provided in each of the R, G, and B EL devices so that the R, G, and B EL devices obtain almost the same brightness characteristic in consideration of change in the characteristics of the R, G, and B EL devices. Therefore, the amplitudes and curves of the R, G, and B EL devices can be set to be different by the amplitude control register 62 and the curve control register 63.

FIG. 4 is a circuit diagram illustrating an example of a pixel adopted into a flat panel display device according to the present invention.

Referring to FIG. 4, a pixel 50 adopted into an organic light emitting display device comprises a first transistor M1, a second transistor M2, a third transistor M3, and a storage capacitor Cst.

The source of the first transistor M1 is connected to first power source ELVdd. The drain of the first transistor M1 is connected to the source of the second transistor M2. The gate of the first transistor M1 is connected to a first node A. The first node A is connected to the drain of the third transistor M3. The first transistor M1 supplies the current corresponding to a data signal to the organic light emitting diode (OLED).

The source of the second transistor M2 is connected to the drain of the first transistor M1. The drain of the second transistor M2 is connected to the anode electrode of the OLED. The gate of the second transistor M2 is connected to an emission control line En to respond to an emission control signal.

Therefore, the second transistor M2 controls the flow of current that flows from the first transistor M1 to the OLED in accordance with the emission control signals to control the emission of the organic light emitting diode (OLED).

Therefore, as described above, the brightness of the pixel unit corresponding to peripheral or ambient light may be controlled by controlling the width of the emission control signals, i.e., ratio of emission intervals and non-emission intervals of the emission control signals.

The source of the third transistor M3 is connected to a data line Dm. The drain of the third transistor M3 is connected to the first node A. The gate of the third transistor M3 is connected to a scan line Sn. And, the third transistor M3 transmits the data signal to the first node A in accordance with a scan signal applied to the gate of the third transistor M3.

The first electrode of the storage capacitor Cst is connected to the first power source ELVdd, and the second electrode of the storage capacitor Cst is connected to the first node A. The storage capacitor Cst charges charge in accordance with the data signal and applies a signal to the gate of the first transistor M1 in one frame by means of the charged charge so that the operation of the first transistor M1 is maintained in one frame.

The foregoing embodiment of the present invention relates to a flat panel display device that controls the brightness of the pixel unit to correspond to the brightness of peripheral or ambient light. Peripheral or ambient light external of the pixel unit is sensed in one frame unit during a period immediately before an initial screen is displayed on the pixel unit since power has been supplied, and an initial screen originally displayed on the pixel unit is displayed at a brightness level corresponding to the brightness level of the peripheral or ambient light.

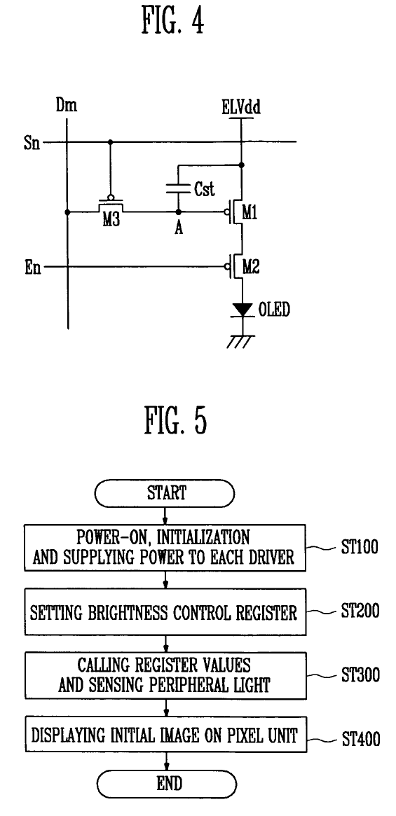

FIG. 5 is a flow chart illustrating a driving method for a flat panel display device according to an embodiment of the present invention.

Referring to FIGS. 1 to 5, a method of driving a flat panel display device according to an embodiment of the present invention will be described in detail.

First, a timing controller 600 receives power signals and initialization signals from an external source and supplies driving power to each component such as a scan driver 200 and a data driver 300 (ST 100). At this time, the scan driver 200 and the data driver 300 are controlled, respectively, for system stabilization. And, driving power is not provided to a pixel unit 100, before voltages required in power lines and data lines are charged, although the power signals have been supplied. Here, the driving power input to the scan driver 200 and the data driver 300 means driving power for driving a dot clock signal DOTCLK, horizontal/vertical synchronizing signals HSync, VSync, the scan driver and the data driver.

Next, a plurality of register set values for controlling the initial brightness of the pixel unit are stored (ST 200), i.e., for displaying at a brightness level corresponding to a brightness level of peripheral or ambient light before the initial screen is displayed by the pixel unit, and the register set values for controlling the brightness level can be set as gamma values corresponding to each gray scale, as described with reference to FIGS. 3 and 4. Also, the brightness level of each pixel corresponding to the brightness level of peripheral or ambient light may be controlled by controlling the ratio of emission intervals and non-emission intervals of the emission control signals transmitted to each of the plurality of pixels.

Meanwhile, the operation of the second step (ST 200) is to be performed after the system is stabilized through the first step (ST 100).

Next, the level of brightness of the peripheral or ambient light is sensed by an optical sensor 510 provided in a brightness control unit 500 to output sense signals corresponding thereto, and the register values corresponding to predetermined sense signals corresponding to the brightness level of the peripheral or ambient light among the plurality of register values set in the second step (ST 200) are selected and called (ST 300).

Also, in the third step (ST 300) the level of brightness of the peripheral or ambient light is sensed in one frame unit using a vertical synchronizing signal Vsync before an initial image is displayed on the pixel unit since the operation of the second step (ST 200) has been performed.

As described above, if the level of brightness of peripheral or ambient light is sensed before an initial screen is displayed on the pixel unit and then predetermined register values are selected through the sense signals corresponding thereto, the initial screen is displayed by means of the level of brightness controlled thereby (ST 400).

That is, the fourth step (ST 400) is for displaying an initial screen having a level of brightness that is controlled in the third step (ST 300) and for displaying an initial screen of the pixel unit by applying the level of brightness corresponding to the sense signals sensed just before an image of the pixel unit is displayed in the third step (ST 300).

Although embodiments of the present invention have been illustrated and described, it would be appreciated by those skilled in the art that changes could be made without departing from the principles and spirit of the invention, the scope of which is defined in the claims and their equivalents.

A flat panel display device and a control method of the same according to the present invention allows an initial screen to be light-emitted at a level of brightness corresponding to a level of brightness of peripheral or ambient light by controlling data signals and emission control signals corresponding to the peripheral or ambient light before a pixel unit displays an image and thereby enhancing visibility of a display.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A flat panel display device, comprising:
a pixel unit comprising a plurality of scan lines, a plurality of emission control lines and a plurality of data lines, and displaying an image corresponding to data signals transmitted to the plurality of data lines;
a scan driver transmitting scan signals to the scan lines and transmitting emission control signals to the emission control lines;
a data driver transmitting the data signals to the data lines;
a timing controller providing control signals and/or data to the scan driver and the data driver; and
a brightness control unit generating sense signals corresponding to a level of brightness of peripheral light and controlling the brightness of the pixel unit based on the sense signals,
wherein the brightness control unit senses the level of brightness of the peripheral light before an initial screen is displayed on the pixel unit and controls the initial screen displayed on the pixel unit at a level of brightness corresponding to the level of brightness of the peripheral light

2. The flat panel display device as claimed in claim 1, wherein the brightness control unit is provided in the timing controller.

3. The flat panel display device as claimed in claim 1, wherein the flat panel display device is an organic light emitting display device.

4. The flat panel display device as claimed in claim 1, wherein the brightness control unit comprises:
an optical sensor sensing the level of brightness of peripheral light in a plurality of steps, and outputting sense signals corresponding to the level of brightness of the respective steps;
a register generator setting and storing a plurality of brightness control register values to control the level of brightness of the pixel unit by corresponding to the sense signals; and
a conversion processor outputting control signals that select the set values of the registers using the sense signals.

5. The flat panel display device as claimed in claim 4, wherein the brightness control unit further includes a counter counting a predetermined period in one frame by being synchronized with an external vertical synchronizing signal.

6. The flat panel display device as claimed in claim 4, wherein the optical sensor senses peripheral light in one frame unit using the vertical synchronizing signal Vsync before an image is displayed on the pixel unit.

7. The flat panel display device as claimed in claim 4, wherein the brightness register values are set to be gamma values corresponding to each gray scale.

8. A control method of a flat panel display device, comprising the steps of:
receiving external power supply signals and initial signals and supplying driving power supply to each component including a scan driver and a data driver;
storing a plurality of register set values for controlling the level of brightness of an initial screen of a pixel unit;
outputting sense signals by sensing peripheral light and selecting register values corresponding to predetermined sense signals corresponding to the level of brightness of the peripheral light among the plurality of register set values; and
displaying the initial screen on the pixel unit by applying the level of brightness controlled by the register values.

9. The control method of a flat panel display device as claimed in claim 8, wherein the register set values for controlling the brightness are set to be gamma values corresponding to each gray scale.

10. The control method of a flat panel display device as claimed in claim 8, wherein the peripheral light is sensed in one frame unit using a vertical synchronizing signal Vsync before an image is displayed on the pixel unit.

11. The control method of a flat panel display device as claimed in claim 8, wherein the flat panel display device is an organic light emitting display device.

12. A control method of a flat panel display device, wherein a control method of a flat panel display device displays an image by receiving emission control signals and data signals, comprising the steps of:
(a) receiving external power supply signals and initialization signals and supplying driving power supply to each component including a scan driver and a data driver;
(b) controlling emission control signals or data signals corresponding to the level of brightness of peripheral light; and
(c) allowing the pixel unit to display an initial screen having a level of brightness controlled through step (b) by supplying the driving power supply to the pixel unit.

13. The control method of a flat panel display device as claimed in claim 12, wherein step (b) comprises the steps of:
(b-1) storing a plurality of register set values for controlling the level of brightness of the initial screen; and
(b-2) sensing the level of brightness of the peripheral light to output sense signals corresponding thereto, and calling the register values corresponding to the sense signals among the plurality of register values.

14. The control method of a flat panel display device as claimed in claim 13, wherein when outputting the sense signals in step (b-2), it senses the peripheral light in one frame unit before the initial screen is displayed since the register set values has been stored and outputs the sense signals sensed just before the initial screen is displayed

15. The control method of a flat panel display device as claimed in claim 12, wherein the flat panel display device is an organic light emitting display device.
